(19) United States
(12) Patent Application Publication
(10) Pub. No.: US 2019/0127890 A1
(43) Pub. Date: May 2, 2019

(54) PROPYLENE TERPOLYMER FOR FILAMENT FOR 3D PRINTER

(71) Applicant: BASELL POLIOLEFINE ITALIA S.R.L., Milano (IT)

(72) Inventors: ROBERTO DE PALO, FERRARA (IT); CLAUDIO CAVALIERI, FERRARA (IT)

(73) Assignee: BASELL POLIOLEFINE ITALIA S.R.L., MILANO (IT)

(21) Appl. No.: 16/094,643

(22) PCT Filed: Mar. 20, 2017
(86) PCT No.: PCT/EP2017/056515

§ 371 Date: Oct. 18, 2018

(30) Foreign Application Priority Data
Apr. 22, 2016 (EP) 16166590.6

(51) Int. Cl. D01F 6/30; B33Y 70/00; C08F 210/16; C08F 210/06

(52) U.S. Cl. CPC D01F 6/30; B33Y 70/00; B33Y 80/00; C08F 210/06; C08F 210/16

(57) ABSTRACT

The present disclosure provides a filament for use in an extrusion-based additive manufacturing system made from or containing a propylene terpolymer containing (a) ethylene and 1-butene or (b) ethylene and 1-hexene, as comonomers having MFR L (Melt Flow Rate according to ISO 1133, condition L, at 230° C. and 2.16 kg load) from about 1 to about 20 g/10 min; and xylene solubles measured at 25° C. from about 3 wt % to about 30 wt %, based upon the weight of the propylene terpolymer.

### FIELD OF THE INVENTION

In general, the present disclosure relates to the field of chemistry. More specifically, the present disclosure relates to polymer chemistry. In particular, the present disclosure relates to a filament made from or containing a propylene terpolymer, for use in an extrusion-based 3D printer.

### BACKGROUND OF THE INVENTION

An extrusion-based 3D printer is used to build a 3D model from a digital representation of the 3D model in a layer-by-layer manner by extruding a flowable modeling material. A filament of the modeling material is extruded through an extrusion tip carried by an extrusion head, and is deposited as a sequence of roads on a substrate in an x-y plane. The extruded modeling material fuses to deposited modeling material, and solidifies upon a drop in temperature. The position of the extrusion head relative to the substrate is then incremented along a z-axis (perpendicular to the x-y plane), and the process is then repeated to form a 3D model resembling the digital representation. Movement of the extrusion head is performed under computer control, in accordance with build data that represents the 3D model. The build data is obtained by slicing the digital representation of the 3D model into multiple horizontally sliced layers. Then, for each sliced layer, the host computer generates a build path for depositing roads of modeling material to form the 3D model.

In the printing process, the filament changes the material of the filament, thereby changing the final mechanical and aesthetic properties of the finished object. In some instances, polylactic acid (PLA) or acrylonitrile, butadiene, styrene (ABS) polymer or polyamides are used for filaments.

It is desirable for the filament to have a constant diameter (in some instance, 1.75 mm or 3 mm); otherwise, finely tuning the amount of material in the printed object is challenging. It is difficult to achieve a constant diameter for the filament, which is believed to depend on the characteristics of the polymer.

It is further desirable that the filament be printable, which, as the term “printable” is used herein, means the filament achieves appropriate adhesion with the plate and among the layers.

### SUMMARY OF THE INVENTION

The present disclosure provides a filament for use in an extrusion-based additive manufacturing system made from or containing a propylene terpolymer containing (a) ethylene and 1-butene or (b) ethylene and 1-hexene, as comonomers having:
MFR L (Melt Flow Rate according to ISO 1133, condition L, at 230° C. and 2.16 kg load) ranging from about 1 to about 20 g/10 min; and
xylene solubles measured at 25° C. from about 3 wt % to about 30 wt %, based upon the weight of the propylene terpolymer.

### BRIEF DESCRIPTION OF THE DRAWINGS

The FIGURE is a front view of a sample used in the print tests. The units of measure are mm. As shown, the printed sample was 5 mm thick.

### DETAILED DESCRIPTION OF THE INVENTION

In a general embodiment, the present disclosure provides a filament for use in an extrusion-based additive manufacturing system made from or containing a propylene terpolymer containing (a) ethylene and 1-butene or (b) ethylene and 1-hexene, as comonomers having:
MFR L (Melt Flow Rate according to ISO 1133, condition L, at 230° C. and 2.16 kg load) from about 1 to about 20 g/10 min, alternatively from about 2 to about 15 g/10 min; alternatively from about 3 to about 12 g/10 min; and
xylene solubles measured at 25° C. from about 3 wt % to about 30 wt % ; alternatively from about 4 wt % to about 25 wt %; alternatively from about 6 wt % to about 15 wt %, based upon the weight of the propylene terpolymer.

As used herein, the term “terpolymer” refers to a polymer formed from only three comonomers, such as (a) propylene, ethylene and 1-butene or (b) propylene, ethylene and 1-hexene.

In some embodiments, the propylene terpolymer has:

(a) an ethylene derived units content in the range from about 1.0 wt % to about 20.0 wt %; alternatively from about 1.0 to about 15.0 wt %; alternatively from about 2.0 wt % to about 10.0 wt %; and

(b1) an 1-butene- or (b2) an 1-hexene-derived units content in the range from about 2.0 wt % to about 22.0 wt %; alternatively from about 3.0 wt % to about 18.0 wt %; alternatively from about 4.0 wt % to about 12.0 wt %;

The sum of the contents of (a) propylene derived units, ethylene derived units and 1-butene or (b) propylene derived units, ethylene derived units, 1-hexene derived units, is 100 wt %, in the respective terpolymers.

In some embodiments, the propylene terpolymer is extruded in a filament having a constant diameter. In some embodiments, the diameter of the filament is about 1.75 mm or about 3 mm. In some embodiments, other diameters are used. In some embodiments, the variation from the nominal diameter is +/−0.05 mm, alternatively +/−0.03 mm. In some embodiments, the diameter of the filament is about 1.75 mm +/−0.05 mm or about 3 mm +/−0.05 mm. In some embodiments, the diameter of the filament is about 1.75 mm +/−0.03 mm or about 3 mm +/−0.03 mm.

It is believed that when amorphous polymeric materials are used, the polymeric materials have little or no ordered arrangements of their polymer chains in their solid states. It is believed that this lack of arrangments reduces the effects of curling and plastic deformation in the resulting 3D model or support structure.

While it is believed that crystalline or semicrystalline polymer can exhibit superior mechanical properties than amorphous polymers, it is also believed that crystalline or semicrystalline polymers show undesirable shrinkage effects both when the extruded road is deposited to form a portion of a layer of a 3D model and when the road is cooled. As such, it is further believed that the shrinkage effects renders the crystalline or semicrystalline polymers unsuitable for building 3D objects in an extrusion-based additive manufacturing process.

Contrary to the belief of persons of ordinary skill in the art, the present disclosure provides a semi-crystalline propylene ethylene copolymer suitable for building a 3D model.

Commercially-available examples of the propylene terpolymer include Adsyl 5 C30F sold by LyondellBasell.

In some embodiments, the filament is made from or contains additionally additives such as antioxidants, slipping agents, process stabilizers, antiacid, and nucleants.

In some embodiments, the filament is made from or contains additionally fillers such as talc, calcium carbonate, wollastonite, glass fibers, glass spheres, and carbon derived grades.

In some embodiments, the filament is made from or contains additionally wood powder, metallic powder marble powder and similar materials.

The following examples are given to illustrate and not to limit the present invention.

### EXAMPLES

The data of the propylene polymer materials were obtained according to the following methods:

Xylene-Soluble Fraction at 25° C.

The Xylene Soluble fraction was measured according to ISO 16152, 2005, but with the following deviations (between parentheses).

The solution volume was 250 ml (200 ml).

During the precipitation stage at 25° C. for 30 min, the solution, for the final 10 minutes, was kept under agitation by a magnetic stirrer (30 min, without any stirring at all).

The final drying step was done under vacuum at 70° C. (100° C.).

The content of the xylene-soluble fraction was expressed as a percentage of the original 2.5 grams and then, by difference (complementary to 100), the xylene unsoluble %.

### Comonomer (C2 and C4) Content Determinated by Using ¹³C NMR

¹³C NMR spectra of base polymers and their fractions were acquired on a Bruker AV600 spectrometer equipped with cryo probe, operating 150.91 MHz MHz in the Fourier transform mode at 120° C. The peak of the S66 carbon was used as internal reference at 29.7 ppm. (The nomenclature was according to C. J. Carman, R. A. Harrington and C. E. Wilkes, “Monomer Sequence Distribution in Ethylene-Propylene Rubber Measured by 13C NMR. 3. Use of Reaction Probability Mode,” 10 Macromolecules 536 (1977).) About 30 mg of sample were dissolved in 0.5 ml of 1,1,2,2 tetrachloro ethane d2 at 120° C. Each spectrum was acquired with a 90° pulse, 15 seconds of delay between pulses and CPD to remove 1H-¹³C coupling. 512 transients were stored in 65 K data points using a spectral window of 9000 Hz. The assignments of the spectra were made according to Kakugo (M. Kakugo, Y. Naito, K. Mizunuma and T. Miyatake, “Carbon-13 NMR determination of monomer sequence distribution in ethylene-propylene copolymers prepared with δ-titanium trichloride-diethylaluminum chloride” 15 Macromolecules 1150 (1982)) and [E. T. Hsieh, J. C. Randall, 15 Macromolecules 353-360 (1982)].

Triad distribution was obtained using the following relations:

PPP=100 I₁₀/Σ

PPE=100 I₆/ΣEPE=100 I₅/Σ

BBB=100 I₃/Σ

BBE=100 I₂/Σ

EBE=100 I₁₁/Σ

XEX=100 I₁₂/Σ

XEE=100 (I₁+I₄)/Σ

EEE=100 (0.5 I₉+0.25 (I₇+I₈))/Σ

wherein

Σ=I₁+I₂+I₃+I₄+I₅+I₆+0.25 I₇+0.25 I₇+0.25 I₈+0.5 I₉+I₁₀+I₁₁+I₁₂

and wherein X is propylene (P) or 1-butene (B), and I₁ to I₁₂ are the areas of the corresponding carbon atoms as reported below (only selected triads and assignments being reported):

| Number | Chemical Shift (ppm) | Carbon | Sequence |
|---|---|---|---|
| I₁ | 37.64-37.35 | S_{αδ} | PEE |
| I₂ | 37.35-37.15 | T_{βδ} | BBE |
| I₃ | 35.27-34.92 | T_{ββ} | BBB |
| I₄ | 34.39-33.80 | S_{αδ} | BEE |
| I₅ | 33.13 | T_{δδ} | EPE |
| I₆ | 30.93-30.77 | T_{βδ} | PPE |
| I₇ | 30.39 | S_{γδ} | BEEE |
| I₈ | 30.29 | S_{γδ} | PEEE |
| I₉ | 29.97 | S_{δδ} | EEE |
| I₁₀ | 29.14-28.31 | T_{ββ} | PPP |
| I₁₁ | 26.70-26.55 | 2B₂ | EBE |
| I₁₂ | 24.88-24.14 | S_{ββ} | XEX |

The molar content of ethylene (E), of propylene (P) and of 1-butene (B) was obtained from triads using the following relations:

E (m %)=EEE+XEE+XEX

P (m %)=PPP+PPE+EPE

B (m %)=BBB+BBE+EBE

Melt Flow Rate (MFR)

The melt flow rate MFR of the polymer was determined according to ISO 1133 (230° C., 2.16 Kg).

The Following Polymers were Used

PP1
Propylene homopolymer having a MFR of 6.5 and a fraction soluble in xylene at 25° C. of <4 wt %, based upon the weight of the propylene homopolymer.

PP2
A filament of diameter 1.75 mm sold under the tradename PP REPRAP BLACK FILAMENT German RepRap PP Filament 600 g, made from or containing a random propylene ethylene copolymer having an ethylene content of 3 wt %, based upon the weight of the random propylene ethylene copolymer, an MFR of 2 dl/10 min, and a fraction soluble in xylene at 25° C. of 6.2 wt %, based upon the weight of the random propylene ethylene copolymer.

PP3
Propylene terpolymer sold under the tradename Adsy 5 C30F being a propylene ethylene 1-butene terpolymer having an ethylene content of 3.3 wt %, based upon the weight of the propylene terpolymer, a 1-butene content of 6.3 wt %, based upon the weight of the propylene terpolymer, MFR of 5.2 g/10 min, and a fraction soluble in xylene at 25° C. of 10.3 wt %, based upon the weight of the propylene terpolymer.

Polymer PP1 and PP3 were exerted to form a filament having 1.75 mm of diameter. To extrude the PP1, 10 wt % of talc, based upon the total weight of the composition, was added.

Print Test

The printer was a 3D Rostock delta printer. The printer conditions were the following:

| | | |
|---|---|---|
| Filament diameter | mm | 1.75 ± 0.03 |
| Nozzle diameter | mm | 0.4 |
| Temperature first layer | ° C. | 245 |
| Temperature other layers | ° C. | 245 |
| | | 1 |
| Layer high | mm | 0.2 |
| Temperature plate | ° C. | 100 |
| Support material to | | vinylic glue |
| adhere on the plate | | |
| Plate material. | | glass |
| infill | | 100% |
| Printer speed | mm/min | 3600 |
| Speed first layer | | 60% |
| Speed other layers | | 100% |
| Speed infill | mm/min | 4.000 |

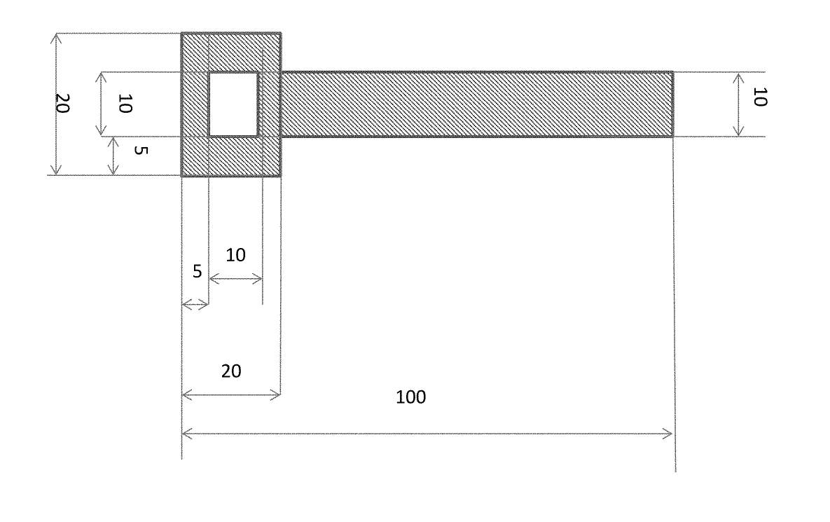

The printed sample in shown in FIG. 1. For each filament, 5 printer tests were carried out. The print was stopped when one side of the object was detached from the plane, thereby preventing the print of the object. The results are reported on Table 1.

TABLE 1

| | height before detach |
|---|---|
| | (Z) (mm) (average |
| Material | measure) |
| PP1* | 0.8 |
| PP2* | 1.2 |
| PP3 | full (5 mm) |

*comparative

What is claimed is:

1. A filament for use in an extrusion-based additive manufacturing system comprising:
a propylene terpolymer comprising (a) ethylene and 1-butene or (b) ethylene and 1-hexene, as comonomers having:
MFR L (Melt Flow Rate according to ISO 1133, condition L, at 230° C. and 2.16 kg load) from 1 to 20 g/10 min; and
xylene solubles measured at 25° C. from 3 wt % to 30 wt % based upon the weight of the propylene terpolymer.

2. The filament according to claim 1, wherein, in the propylene terpolymer, the xylene solubles measured at 25° C. is from 4 wt % to 25 wt %, based upon the weight of the propylene terpolymer.

3. The filament according to claim 1, wherein the propylene terpolymer has a MFR L ranging from 2 to 15 g/10 min.

4. The filament according to claim 1, wherein, in the propylene terpolymer, the xylene solubles measured at 25° C. is from 6 wt % to 15 wt %, based upon the weight of the propylene terpolymer.

5. The filament according to claim 1, wherein, in the propylene terpolymer, (a) the ethylene derived units content ranges from 1.0 wt % to 20.0 wt % and (b1) the 1-butene- or (b2) the 1-hexene-derived units content ranges from 2.0 wt % to 22.0 wt %.

6. The filament according to claim 1, wherein, in the propylene terpolymer, (a) the ethylene derived units content ranges from 1.0 wt % to 15.0 wt % and (b1) the 1-butene- or (b2) the 1-hexene-derived units content ranges from 3.0 wt % to 18.0 wt %.

7. The filament according to claim 1, wherein the filament has a constant diameter having a variation of +/−0.05 mm.

8. The filament according to claim 1, wherein the filament has a constant diameter having a variation of +/−0.03 mm.

9. The filament according to claim 1, wherein the filament has a diameter selected from the group consisting of (a) 1.75 mm+/−0.05 mm and (b) 3 mm +/−0.05 mm.

10. The filament according to claim 1, wherein the filament has a diameter selected from the group consisting of (a) 1.75 mm+/−0.03 mm and (b) 3 mm+/−0.03 mm.

11. The filament according to claim 1, wherein the propylene terpolymer contains ethylene and 1-butene.

12. (canceled)

13. The filament according to claim 1, wherein the propylene terpolymer contains ethylene and 1-hexene.

14. An extrusion-based additive manufacturing system comprising:
(I) a filament comprising:
(A) a propylene terpolymer comprising (a) ethylene and 1-butene or (b) ethylene and 1-hexene, as comonomers having:
MFR L (Melt Flow Rate according to ISO 1133, condition L, at 230° C. and 2.16 kg load) from 1 to 20 g/10 min; and
xylene solubles measured at 25° C. from 3 wt % to 30 wt %, based upon the weight of the propylene terpolymer.

15. A 3D printed article prepared from an extrusion-based additive manufacturing system comprising:
(I) a filament comprising:
(A) a propylene terpolymer comprising (a) ethylene and 1-butene or (b) ethylene and 1-hexene, as comonomers having:
MFR L (Melt Flow Rate according to ISO 1133, condition L, at 230° C. and 2.16 kg load) from 1 to 20 g/10 min; and
xylene solubles measured at 25° C. from 3 wt % to 30 wt %, based upon the weight of the propylene terpolymer.
